(19) United States
(12) Patent Application Publication
(10) Pub. No.: US 2026/0340263 A1
(43) Pub. Date: Oct. 29, 2026

(54) NEARLY REAL-TIME TRANSCRIPTION AND ARTIFICIAL INTELLIGENCE SUMMARY OF MEETINGS

(71) Applicant: Notion Labs, Inc., San Francisco, CA (US)

(72) Inventors: Julia Rudansky, San Francisco, CA (US); Varun Krishna Rau, San Francisco, CA (US); Vincenzo Vitiello, San Francisco, CA (US); Francisco Ramos Paz Pereira da Costa, San Francisco, CA (US); Michael Joseph Johnston, San Francisco, CA (US)

(21) Appl. No.: 19/235,453

(22) Filed: Jun. 11, 2025

Related U.S. Application Data
(60) Provisional application No. 63/796,248, filed on Apr. 28, 2025.

(51) Int. Cl. G06F 40/166; G10L 15/16; G10L 15/183; G10L 15/26

(52) U.S. Cl. CPC G06F 40/166; G10L 15/26; G10L 15/16; G10L 15/183

(57) ABSTRACT

The present disclosure provides systems, methods, and computer-readable media for transcribing a meeting in nearly real time and generating a summary of the meeting using artificial intelligence (AI). A selection is received from a user of an electronic device to begin transcription of a meeting. Text based on audio content from the meeting is responsively generated, while the meeting is ongoing and in nearly real time, within a transcription block. A transcript of the text based on audio content from the meeting is provided to an AI tool, along with workspace data associated with the meeting. A summary of the transcript is received from the AI tool and displayed within the transcription block.

### CROSS-REFERENCE TO RELATED APPLICATION(S)

This application claims priority to and the benefit of U.S. Provisional Application No. 63/796,248, titled “NEARLY REAL-TIME TRANSCRIPTION AND ARTIFICIAL INTELLIGENCE SUMMARY OF MEETINGS” and filed on Apr. 28, 2025. The content of the aforementioned application is herein incorporated by reference in its entirety.

### BACKGROUND

A virtual meeting is a form of communication that enables people in different physical locations to meet in the same virtual space using internet-connected devices. Virtual meetings typically involve meeting participants sharing video and/or audio streams with other participants and involve the sharing of information regarding a topic of interest to the meeting participants. It is also commonplace for in-person meetings, which include many of the same characteristics.

A meeting transcript is a written record of the audio and sometimes video content of a meeting, encompassing information that is provided verbally during the meeting. The process of generating a meeting transcript is called “transcribing” and may include the addition of elements like timestamps and speaker identification to the transcript.

### BRIEF DESCRIPTION OF THE DRAWINGS

Reference will now be made, by way of example, to the accompanying drawings, which show example embodiments of the present application and in which:

FIG. 1 is a block diagram illustrating a platform that may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4 illustrates an example meeting environment for transcribing and summarizing a meeting within a transcription block.

FIG. 5 is an illustration of an example transcription block within a page.

FIG. 6 is an illustration of an example page including a transcription block and query interface for searching content within the transcription block.

FIG. 7 is a flow diagram illustrating an example method of displaying a summary of a meeting within a transcription block.

FIG. 8 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for systems, methods, and computer-readable media for transcribing a meeting in nearly real time and generating a summary of the meeting using artificial intelligence (AI). In many meeting scenarios, whether the meeting is virtual or in person, one or more meeting participants take notes as the meeting progresses to aid in recalling the content of the meeting and in keeping track of information newly learned in the meeting. However, creating accurate meeting notes manually is time-consuming and distracts meeting participants from being mentally present within the meeting. Additionally, manually captured notes are not easily shared between meeting participants and/or others who did not attend the meeting, leading to information becoming lost and inefficient duplicate efforts to obtain the same information.

Automated tools exist for transcribing meetings and/or summarizing the content of a meeting, which attempt to relieve the burden of manual note-taking. However, these tools may be disconnected from other sources of relevant information, such as a meeting participant's workspace application, messages, emails, calendar, and the like, which could be used to supplement meeting content and/or enable the generation of a more accurate meeting summary. Likewise, existing automated transcription/summarization tools may not include tools for meeting participants to collaboratively edit a transcript of a meeting and/or add notes providing additional context in real time, or nearly real time, as the meeting progresses.

The present technology overcomes these limitations of existing automated transcription/summarization tools by providing a transcription block (e.g., a customizable unit of information including a meeting transcription) within a workspace application that generates a transcription of a meeting in nearly real time and automatically summarizes the meeting using an AI tool. The AI tool is provided with workspace data that may include data from elsewhere in a workspace application, data from connected applications, and/or a predetermined or example format for the summary to be generated. This supplemental workspace data enables the AI tool to include additional content and context in the meeting summary and to more closely track the note-taking preferences of a user, aiding in the generation of more thorough and understandable summaries than existing solutions. Additionally, the transcription block is accessible to and editable by multiple meeting participants simultaneously, enabling the transcription to be edited as the meeting progresses and for participants to add notes providing additional context to the transcription within the transcription block. The AI tool may use the changes made to the transcription block by meeting participants as additional input when generating a meeting summary, enabling the summary to be more tailored and accurate to information of interest to the meeting participants.

Additionally, existing tools may require manual activation for a transcript/summary to be captured, which often leads to users forgetting to record a meeting or multiple transcriptions of the same meeting being generated at once, which expends computational resources unnecessarily. In some embodiments, the present technology overcomes this limitation by automatically detecting that a user has entered a meeting and responsively notifying the user with a prompt to begin transcribing the meeting, reducing the instances in which the opportunity to automatically capture a transcription/summary of a meeting is missed. Additionally or alternatively, duplicate transcriptions of the same meeting may be detected and automatically stopped in order to reduce the computational resources spent on redundant transcription efforts and centralize transcription/summary processes in a single transcription block.

An additional shortcoming of existing automated transcription/summarization tools is that these tools may lack functionality for aiding participants in understanding the meeting while the meeting itself is still ongoing (e.g., because a summary is not generated until the meeting ends). In some embodiments, the present technology addresses this shortcoming by displaying a summary of the meeting up to the present time within the transcription block, or within a video/chat interface of the meeting itself, before transcription of the meeting has finished. Thus, meeting participants are able to reference the summary while still participating in the meeting and thereby more effectively discuss/respond to topics within the meeting. Furthermore, the present technology may include a query interface for asking the AI tool questions about the meeting while the meeting is ongoing and for receiving answers to those questions based on a transcript of the meeting and supplemental workspace data. Thus, meeting participants can receive answers to specific questions from the AI tool as the meeting progresses, informing the meeting participants so that they may more effectively engage in meeting discussions.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children is referred to herein as a “render tree.” In one example, page blocks display their content in a new page instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks'content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title and checked: [[“No”]]). The client builds operations to represent the creation of a new block with those attributes. New blocks are not created in isolation: blocks are also added to their parent's content array so they are in the correct position in the content tree. As such, the client also generates an operation to do so. All these individual change operations are grouped into a transaction. Then, the client applies the operations in the transaction to its local state. New block objects are created in memory, and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the/saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then, the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of newly recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

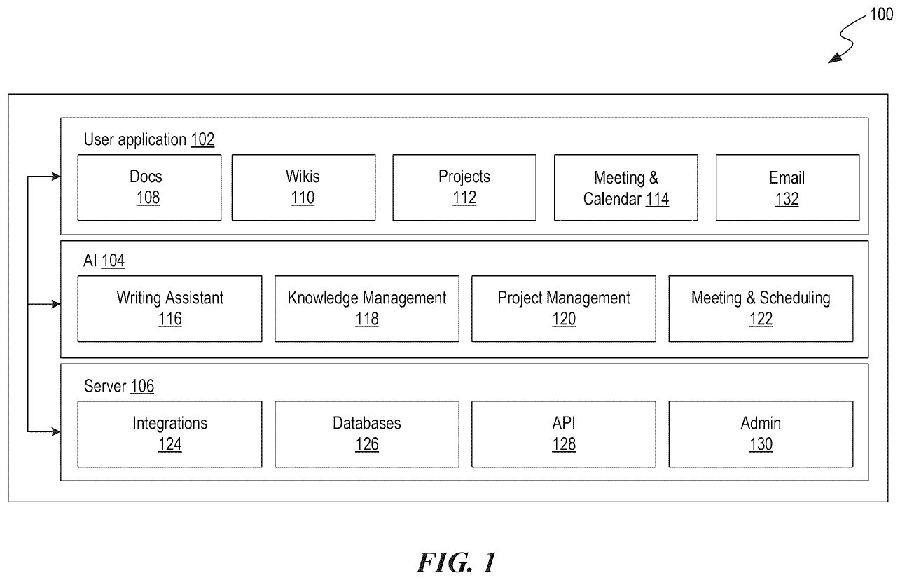

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100, or an embedding of a block within the document. In another example, a wiki can link to a meeting within the calendar.

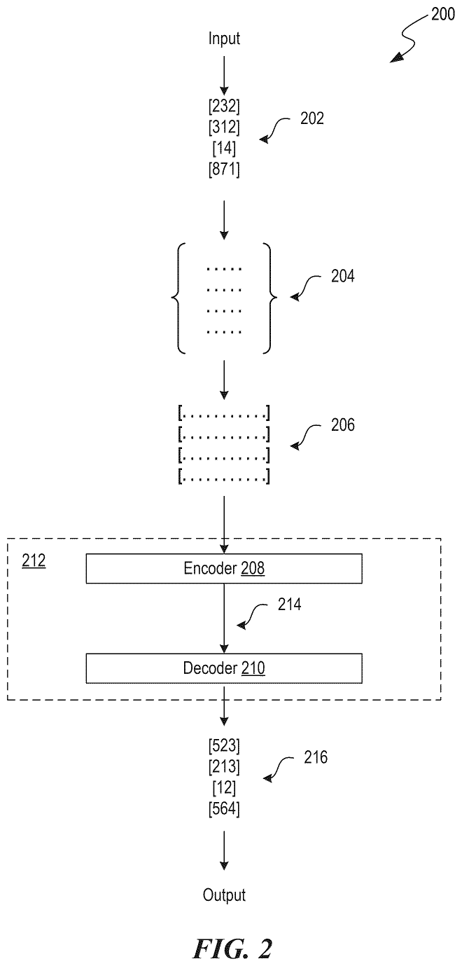

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

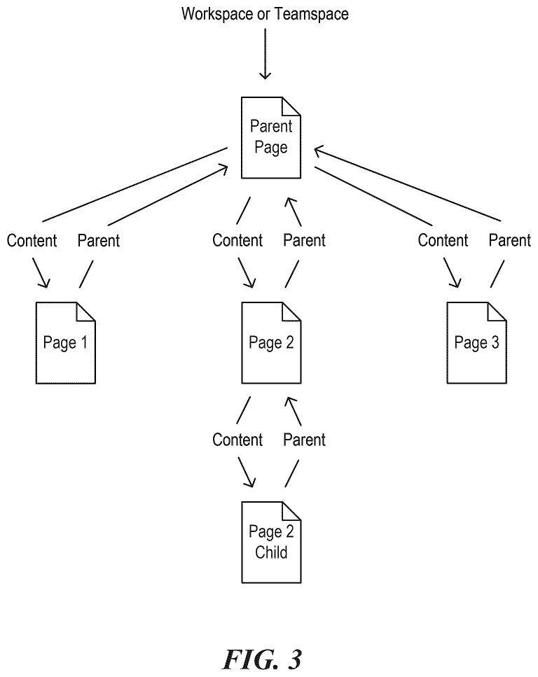

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Example Meeting Environment

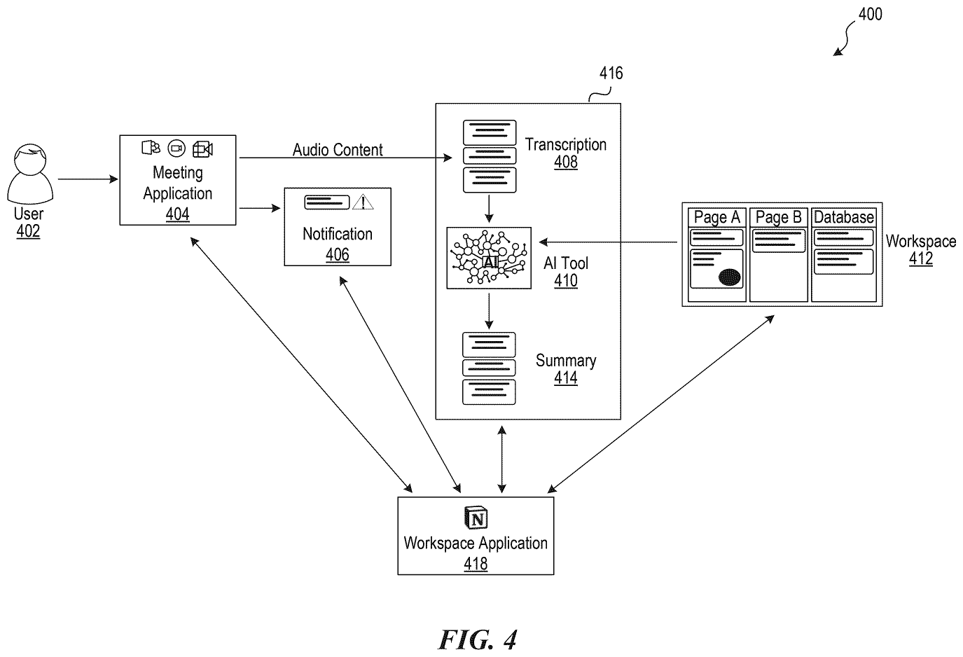

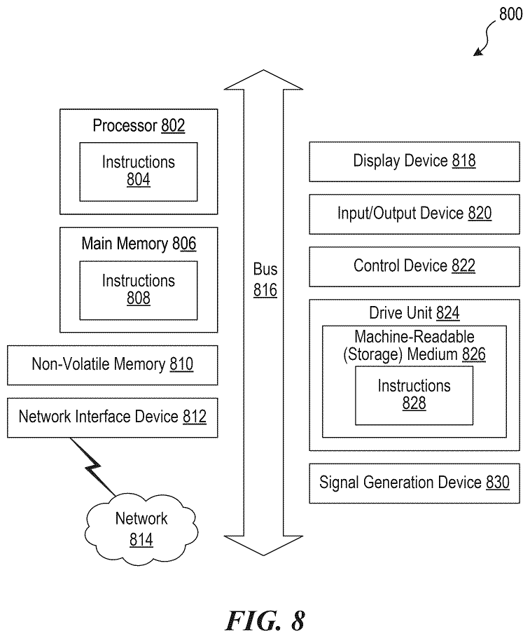

FIG. 4 illustrates an example meeting environment 400 for transcribing and summarizing a meeting within a transcription block 416. The meeting environment 400 includes a user 402, meeting application 404, notification 406, transcription 408, AI tool 410, workspace 412, summary 414, transcription block 416, and workspace application 418. The meeting environment 400 may be implemented using the computer system illustrated and described in more detail with reference to FIG. 8. Likewise, implementations of the meeting environment 400 can include different and/or additional components or can be connected in different ways.

The user 402 is an individual or entity participating in a meeting (e.g., a virtual meeting hosted on a platform such as Zoom®, Microsoft® Teams®, or Google® Meet®, an in-person conversation recorded by an electronic device). The disclosed system can be meeting provider agnostic and can work regardless of the platform used for the virtual meeting, such as Zoom®, Microsoft® Teams®, or Google® Meet®. If a new virtual meeting software is added, the system can seamlessly transcribe the audio from the new virtual meeting without the user having to install a plug-in or upgrade the note-taking system. The user 402 participates in the meeting via a meeting application 404. In embodiments where the meeting is a virtual meeting, the meeting application 404 is an application provided by a platform hosting the meeting that is accessible by users of the platform. In other embodiments where the meeting is in person, the meeting application 404 is an application used to record audio of the in-person meeting.

The meeting environment 400 includes a workspace application 418, which is an application or other software component providing a suite of tools for data and/or project management (e.g., Notion®). In some embodiments, the workspace application 418 detects that a user has entered a meeting (e.g., via the meeting application 404), signaling to the workspace application 418 that the user may wish to generate a transcription of the meeting and/or automatically generate a summary of the meeting.

This detection may be based on activity on an electronic device accessed by the user 402. For example, the activity may include an audio system change (e.g., activation/attachment of an audio device, activity of a process that records audio, and/or other changes to the audio streams of the electronic device) measured via an operating system-level application programming interface (API), which is an API communicatively coupling the workspace application 418 and operating system of the electronic device. In another example, the system can detect a system process that is attached to an audio device and determine that the user is in a meeting that needs to be transcribed. As another example, the activity may include the use of a specified communication protocol (e.g., user datagram protocol (UDP), transmission control protocol (TCP)), which can indicate that an audio stream is being sent from and/or received by the electronic device. As a third example, the activity may be a calendar entry (e.g., an entry within a virtual calendar application such as Notion® Calendar or Google® Calendar) indicating a meeting time, meaning that the calendar entry includes text or other data indicating the user 402 is scheduled to attend a meeting at a specified time. Continuing with the same example, such a calendar entry may be an hour-long entry entitled “Meeting with Product Team” that includes a link to a virtual meeting (e.g., a uniform resource locator (URL) for accessing a meeting application 404) and begins at 10 am Pacific Time on Apr. 25, 2025. As a fourth example, the activity may include a configuration of a page associated with a meeting. The page may be stored within the workspace application 418 and may be associated with a meeting by including data indicating the user 402 is scheduled to attend a meeting at a specified time and/or include a list of participants for a meeting. Continuing with the same example, the page may include text describing a meeting starting at a specified time or a link to a virtual meeting that is interpreted by the workspace application 418 to detect the time at which the user 402 will enter a meeting.

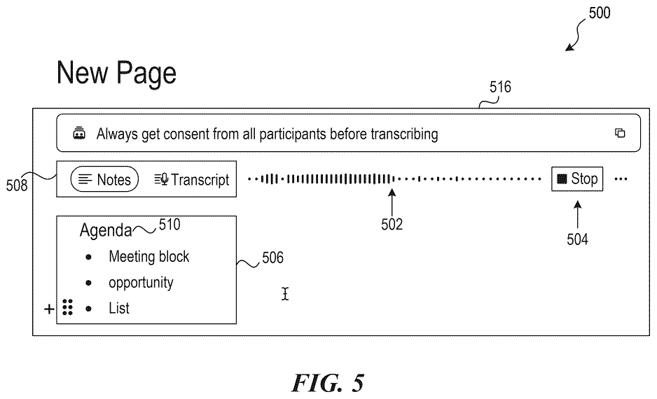

In some embodiments, when the workspace application 418 detects that the user has entered a meeting or is in a meeting, the workspace application 418 causes display of a notification 406 on the electronic device. The notification 406 prompts the user 402 to begin/activate a transcription of the meeting, reminding the user 402 that the content of the meeting can be recorded automatically. The user 402 may interact with the notification 406 (e.g., select an icon within the notification 406 using a mouse cursor) to indicate that transcription of the meeting should begin, thereby signaling the workspace application 418 to begin generating a transcription 408 of the meeting, as described in more detail below. In other embodiments, the workspace application 418 may receive a selection from the user to begin transcription of the meeting via another user interface, such as an interactable element within a transcription block 416. The transcription block 416 is described in more detail below and illustrated in FIG. 5.

In some embodiments, in response to receiving the selection to begin transcription from the user, the workspace application activates a transcription block 416. The transcription block 416 is a block configured to receive audio content from the meeting and generate, while the meeting is ongoing, a transcription 408, which is text based on the audio content from the meeting that includes words being spoken by participants in the meeting. In some embodiments, the text is generated in nearly real time, meaning text corresponding to a particular portion of audio from the meeting is generated and included in the transcription 408 within several seconds (e.g., 10 seconds or less) of receiving the particular portion of audio. As the transcription 408 is generated, the transcription 408 may be included within the transcription block 416 such that the transcription 408 is viewable by the user 402 throughout the meeting. In some embodiments, the transcription block 416 is included in a page and/or a database to which the user 402 has access, and the user may be able to share access to the transcription block 416 with other individuals or entities, such as other participants in the meeting. In these and other embodiments, the user or another individual (e.g., a workspace administrator_) may set a custom retention time for the transcription 408 (e.g., 7 days, 30 days), after which the transcription 408 is deleted. Setting a custom retention time enables an automatic deletion cadence for transcriptions, enabling compliance with data retention policies with less manual oversight.

In some embodiments, the transcription block 416 receives audio content from the meeting via system audio and/or microphone audio streams on the electronic device. Although the meeting includes the user 402 and at least one other participant, the audio content may be received exclusively from the user 402 (e.g., via the system of the electronic device used by the user 402). Receiving only one stream of audio content conserves computational resources that would otherwise be spent on collecting and processing audio content from a plurality of meeting participants, which would ultimately be duplicative for the purposes of generating a transcription 408. However, in some embodiments, more than one meeting participant may activate a transcription of the same meeting (e.g., using separate transcription blocks 416), thereby beginning two transcriptions of the same audio content. Thus, in such embodiments, the workspace application 418 may detect a duplicate transcription of the audio content based on a comparison of the transcription 408 to other transcriptions being generated simultaneously. This comparison may identify that the text of the transcription 408 and another transcription are identical or generally similar and thus denote the other transcription as a duplicate transcription that is being generated unnecessarily. As another example, in embodiments where a configuration of a page is associated with the meeting, the configuration of the page may indicate that multiple meeting participants are transcribing the meeting at once, enabling the workspace application 418 to detect duplicate transcriptions generated by the multiple meeting participants. When a duplicate transcription is detected, the workspace application 418 may discontinue the duplicate transcription to conserve computational resources and consolidate management of transcription of the meeting within a single transcription block 416.

To identify duplicate transcriptions, the system can compare the last 5 or 10 minutes of the multiple transcriptions to determine if they are identical instead of comparing the full transcription because comparing the full transcription would consume too much computational resources. Upon determining that the last 5 or 10 minutes of the multiple transcriptions are identical, the system can determine that the 2 transcriptions are duplicates.

In some embodiments, the transcription block 416 receives audio content from a meeting bot. The meeting bot is an automated meeting participant (e.g., a software component that may include an AI tool 410, as described in more detail below) that is configured by the workspace application 418 to participate in the meeting. The meeting bot may, by virtue of being a participant in the meeting, access audio content from the meeting via an API of the meeting application 404. This audio content may be more detailed than audio content received from a system audio and/or microphone audio stream. For example, the meeting bot may be able to access separate media streams from each participant in the meeting, allowing the transcription 408 to be diarized according to the speaker of each portion of received audio content. The meeting bot may also be able to automatically notify meeting participants while the meeting is ongoing that the meeting is being transcribed and/or ask for consent of the meeting participants to record audio from the meeting. For example, the meeting bot may generate a notification or consent request that is displayed in the video feed of the meeting bot or a chat interface within the meeting application 404. Thus, the meeting bot alleviates the burden on the user 402 to notify other meeting participants that the meeting is being transcribed and enables a more detailed transcription 408 to be created than audio content collected directly from the system of the user 402.

The meeting bot can detect additional information relevant to the meeting, such as providing informative links relating to the content of the meeting. For example, the meeting bot can detect relevant information that is missing in the meeting, such as meeting participants saying, “We need to determine the number of users from the last quarter,” and the meeting bot can obtain that information by searching internal databases. In another example, the meeting bot can detect the participant saying, “We need to find out our competitors'major clients,” and can consequently perform a web search for public information indicating the competitors'major clients. The meeting bot can also provide links to the relevant information during the meeting in the meeting chat.

In some embodiments, the transcription 408 is editable by one or more meeting participants, including the user 402. For example, the user 402 may be able to navigate to an interactable display of the transcription 408 within the transcription block 416 and edit the transcription 408 by adding text, removing text, and/or providing a correction to recurring text used within the transcription 408 (e.g., updating the spelling of a meeting participant's name or specifying the appropriate choice of homophones for the meeting, such as specifying that audio sounding like “sequel” should be transcribed as the acronym “SQL” rather than the word “sequel”). In some embodiments, meeting participants are prevented from editing the transcription 408 directly, preserving a documentation of the meeting that closely tracks what is said during the meeting, but the meeting participants may add comments to the transcription 408 to provide additional context and/or flag potential errors. The comments may be visible to other meeting participants viewing the transcription 408, allowing information associated with the transcript to be shared between meeting participants.

In these and other embodiments, the transcription block 416 includes a notes interface that is also editable by one or more meeting participants including the user. The notes interface can receive text, images, and/or other data from the meeting participants and be dynamically edited by the meeting participants as the meeting progresses, enabling the meeting participants to document information associated with the meeting, provide additional context relevant to the meeting, and/or otherwise communicate with one another. In some embodiments, the transcription 408 and/or notes interface are editable by multiple meeting participants simultaneously, and edits made by one meeting participant appear for other meeting participants in nearly real time. For example, the transcription block may include a conflict-free replicated data type (CRDT), which is a data type that is replicable across a plurality of electronic devices and that includes an algorithm for converging the content within different replicas of the CRDT and resolving inconsistencies between the replicas. In some embodiments, the user 402 grants one or more other meeting participants permission to edit at least one of the transcription 408 or the notes interface within the transcription block 416 by sharing a URL linking to the transcription block 416 with the one or more other meeting participants. The notes interface may be accessed by one or more meeting participants from within the transcription block 416 during and/or after the meeting. Thus, the transcription block 416 serves as a single location in which meeting participants may document and share information associated with the meeting even after the meeting itself has concluded.

In some embodiments, meeting participants interact with the transcription block 416 to start and/or stop generation of the transcription 408. In such embodiments, when the workspace application 418 receives a selection from a meeting participant, via the transcription block, to stop generating the transcription 408, the workspace application 418 may responsively discontinue generation of the transcription 408 and provide, to an AI tool 410, a transcript that includes the text of the transcription 408 after generation is discontinued. Each of the meeting participants can stop the transcription independently. In one embodiment, stopping the meeting transcription can stop the transcription for all the participants. In another embodiment, stopping the meeting transcription can stop the transcription for only the participant requesting the halt. The system can continue the recording for the other participants. The AI tool 410 may be an AI tool 104 as described in relation to FIG. 1 above, may include a commercial AI model such as GPT-4 or Claude 3.7 Sonnet, and/or may include code for invoking such a commercial AI model. The AI tool 410 is configured to receive the transcript and/or other data as input and output a summary 414 of the received transcript that describes the content discussed within the meeting and supplements the transcript with data received from other sources to provide the user 402 with a comprehensive and concise overview of the topics covered in the meeting, outstanding action items from the meeting, topics for further consideration, and the like. In some embodiments, the workspace application 418 receives the summary 414 from the AI tool 410 and causes display of the summary 414 within the transcription block 416 where the summary 414 is viewable by the user 402.

In some embodiments, the AI tool 410 receives workspace data (e.g., from the workspace application 418) in addition to the transcript, which the AI tool 410 processes in combination with the transcript to generate the summary 414. Workspace data is data stored within a workspace 412 and/or data stored within the transcription block 416 other than the transcript itself. The workspace 412 may be a workspace as described above and may be included in/accessible via the workspace application 418. One example of workspace data is a page or a database accessible by the user within the workspace 412. As another example, workspace data may include a predetermined format for the summary 414. The predetermined format may be a template for a summary 414 that is stored within the workspace 412 and is associated with a particular purpose of a meeting or topic of discussion within a meeting. For example, a predetermined format associated with a recruitment meeting may include a table representing characteristics of various candidates for a job position, while a predetermined format associated with a budget meeting may include fields for revenue sources, expenses, and the like. The predetermined format provided to the AI tool 410 may be selected by the user 402 or another AI tool. As a third example, the workspace data may be content from the notes interface in the transcription block 416, such as text or files added to the notes interface by a meeting participant. As a fourth example, the workspace data may be an example summary, which is a summary of meeting content from a previous meeting (e.g., as previously generated by an AI tool 410 or a user 402) that is selected by a user 402 as an example of the format the user 402 desires the AI tool 410 to follow for generating the summary 414. Continuing with the same example, the AI tool 410 may responsively generate a summary 414 with the same or a generally similar format to the example summary but with content relevant to the present meeting/the transcription 408.

In some embodiments, after the transcription 408 is stopped, the transcription 408 is resumed by a meeting participant, which may be the same participant who stopped the transcription or a different participant. In such embodiments, the transcription 408 resumes generating text based on audio content from the meeting within the transcription block 416 and the audio content is received from the meeting participant who resumed the transcription 408. As with initially starting the transcription 408, audio content is only received from one meeting participant to avoid the computational efficiency associated with collecting and processing duplicative streams of audio data. When the transcription 408 is resumed, display of the summary 414 within the transcription block 416 may be discontinued, as the summary 414 will become outdated as new audio content is collected from the meeting. In embodiments where the transcription 408 is stopped once again in response to a selection from a meeting participant, an updated summary 414 based on the updated transcription 408 and/or other data may be displayed within the transcription block 416.

In some embodiments, summaries of the meeting are displayed within the transcription block 416 automatically throughout the meeting (e.g., without a meeting participant needing to stop the transcription 408), continuously informing the meeting participants of information discussed within the meeting and thereby enabling more productive and organized discussion. For example, after the meeting has proceeded for several minutes but before receiving a selection from a meeting participant to stop the transcription 408, the workspace application 418 may provide a second transcript including text based on audio content received from the meeting up to that point to the AI tool 410. The AI tool 410 may then generate a second summary based on the second transcript and/or other data (e.g., workspace data) received by the AI tool 410, and the workspace application may receive the second summary from the AI tool 410. The workspace application 418 can then cause display of the second summary within the transcription block 416, thereby informing meeting participants with access to the transcription block 416 of matters previously discussed within the meeting without requiring manual note-taking actions on behalf of those meeting participants. Additionally or alternatively, the second summary may be displayed within the meeting (e.g., via a video stream and/or chat interface) by a meeting bot to which the workspace application provides the second summary. The meeting bot may also be provided directly with workspace data associated with the meeting (e.g., which the AI tool 410 used to generate the second summary) and may display that workspace data within the meeting in the same or a generally similar manner to the second summary.

In some embodiments, the user 402 and the other meeting participants will not stop the transcription 408 before the meeting concludes. In such embodiments, the workspace application 418 automatically detects when the user 402 leaves the meeting and responsively discontinues the transcription 408 so that computational resources are not needlessly spent on collecting audio content from a meeting that has ended. Detecting that the user 402 has left the meeting may include measuring an audio cessation (e.g., deactivation/detachment of an audio device, discontinuation of a process that records audio, and/or other changes to the audio streams of the electronic device indicating that an audio stream has ended) via an operating system-level application programming interface (API) and/or may include a discontinuation of a specified communication protocol (e.g., user datagram protocol (UDP), transmission control protocol (TCP)), which indicates that an audio stream is no longer being sent from and/or received by the electronic device. In response to detecting the user 402 has left the meeting, the workspace application 418 may discontinue generating text based on audio content from the meeting and provide a transcript of the text generated to that point to the AI tool 410 so that the AI tool 410 may generate a summary of the meeting.

### Example User Interfaces

FIG. 5 is an illustration of an example transcription block 516 within a page 500. In some embodiments, the transcription block 516 is added to the page 500 by a user (e.g., the user 402 described in relation to FIG. 4 above) using a text command entered on the page. Although in FIG. 5 the transcription block 516 is depicted as the only block on the page 500, the present technology is not so limited; one or more other blocks may also be included in the page along with the transcription block 516.

As depicted in FIG. 5, the transcription block 516 includes an audio visualizer 502 that moves based on the audio content being received from a meeting, visually indicating to a user viewing the transcription block 516 that audio content is actively being received. The transcription block 516 also includes a stop/start indicator 504, which may be selected by the user (e.g., by clicking with a mouse cursor) to start/stop generating text based on the audio content received from the meeting (e.g., start/stop generating a transcription 408). For example, as depicted in FIG. 5, text is actively being generated, and thus, the stop/start indicator 504 reads “stop” to indicate to the user that selecting the stop/start indicator 504 will stop transcription.

Additionally, the transcription block 516 includes a notes interface 506 that is editable by one or more meeting participants who can add text, images, and/or other data to the notes interface in near real time. The notes interface 506 may include the same or generally similar features to the notes interface described in relation to FIG. 4 above. The transcription block 516 also includes a navigation bar 508 that enables a user to switch views within the transcription block 516 depending on which icon within the navigation bar 508 is selected. For example, the icon labeled “Notes” is currently highlighted to indicate that the notes interface is being displayed within the transcription block 516. However, when the “Transcript” icon is selected by a user, that icon is highlighted and the text being generated based on the audio content from the meeting is displayed in place of the notes interface 506.

The notes interface 506 can include a summary of the meeting generated by automatically prompting an LLM to produce a summary of the transcription or by obtaining a user-specified prompt requesting information related to the meeting. For example, the user-specified prompt can say, “Please give me the action items from the meeting,” or the user prompt can say, “Please give me the action items that I need to perform from the meeting.”

The system can determine a type of the meeting by, for example, analyzing the content of the transcript and/or obtaining the title of the meeting from a calendar entry. The type of the meeting can include an interview, a team meeting, a product pitch, a brainstorming meeting, etc. Based on the type of the meeting, the system can create a heading 510 for the meeting or can organize the notes interface 506 according to a predetermined template for that type of the meeting.

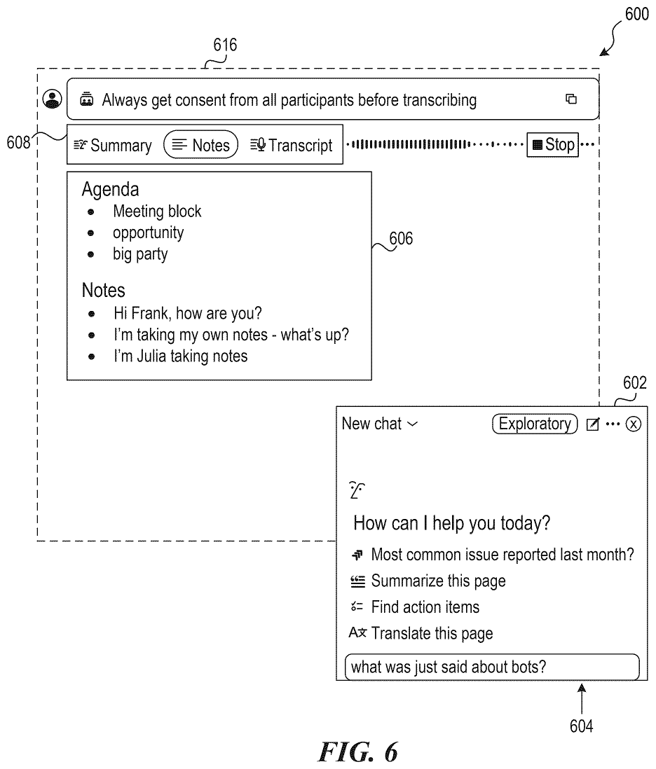

FIG. 6 is an illustration of an example page 600 including a transcription block 616 and query interface 602 for searching content within the transcription block 616. The transcription block 616 is generally the same as the transcription block 516 described in relation to FIG. 5 above, except that different notes have been added to the notes interface 606 and that a “Summary” icon has been added to the navigation bar 608, indicating that a summary of the transcription for the meeting from which audio content is being collected has already been generated (e.g., by an AI tool 410, as described in relation to FIG. 4 above). A user selection of the “Summary” icon causes the summary to be displayed in place of the notes interface 606. The transcription block 616 therefore serves as a single block within a workspace application that may contain a transcription, a summary of that transcription, and notes associated with the meeting being transcribed.

The query interface 602 is a user interface for receiving queries about a meeting from a user. For example, a user may enter a text query associated with the meeting via a search bar 604 included in the query interface 602, which is received by the workspace application hosting the page 600 (e.g., a workspace application 418 as described in relation to FIG. 4 above) and provided to an AI tool (e.g., an AI tool 410, as described in relation to FIG. 4 above), which the workspace application directs to generate an answer to the query. Continuing with the same example, an answer to the query may be received from the AI tool and displayed within the query interface 602.

### Example Summary Display Method

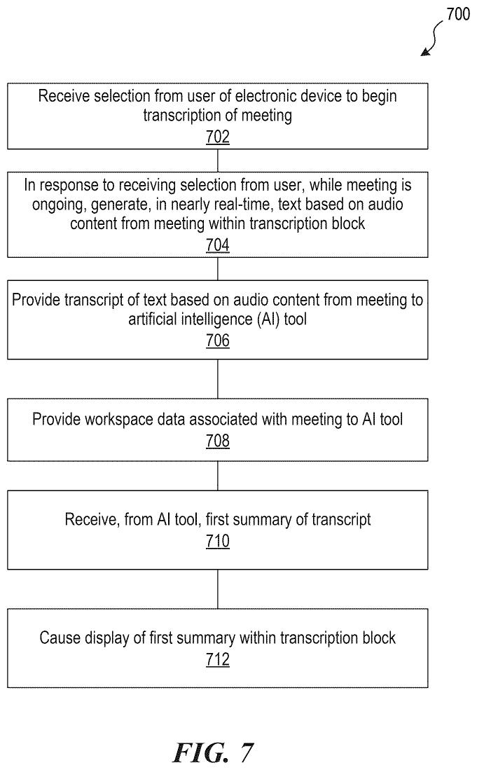

FIG. 7 is a flow diagram illustrating an example method 700 of displaying a summary of a meeting within a transcription block. In some embodiments, the method 700 is performed by components of the example computer system illustrated and described in more detail in relation to FIG. 8 below and/or the workspace application 418 described in more detail in relation to FIG. 4 above. Likewise, embodiments can include different and/or additional operations or can perform the operations in different orders.

In operation 702, a selection is received, from a user of an electronic device, to begin transcription of a meeting. For example, the selection may be received via the user selecting an interactable element of a notification 406, as described in relation to FIG. 4 above and/or a stop/start indicator 504 as depicted in relation to FIG. 5 above.

In some embodiments, a detection is made that the user has entered a meeting. This detection may be based on activity on an electronic device, including at least one of an audio system change measured via an operating system-level API, a use of a specified communication protocol, a calendar entry indicating a meeting time, and/or a configuration of a page associated with a meeting. In such embodiments, display of a notification prompting the user to begin transcription of the meeting may be caused on the electronic device and/or the selection from the user in operation 702 may be received via the user interacting with the notification.

In operation 704, in response to receiving the selection from the user, while the meeting is ongoing, text based on audio content from the meeting is generated, in nearly real time, within a transcription block. For example, the text may be a transcription 408, as described in relation to FIG. 4 above. In some embodiments, at least one of the text based on audio content from the meeting or a notes interface (e.g., as described in relation to FIG. 4 and/or depicted in relation to FIGS. 5 and 6 above) is editable by one or more meeting participants, the one or more meeting participants including the user. For example, the one or more meeting participants may be able to edit the text based on audio content from the meeting and/or the notes interface by adding text, deleting text, or uploading images and/or other data. In some embodiments, the one or more meeting participants receive permission to edit at least one of the text based on audio content from the meeting or the notes interface within the transcription block via a URL shared by the user.

In operation 706, a transcript of text based on audio content from the meeting is provided to an AI tool. For example, the AI tool may be the same as or generally similar to an AI tool 410, as described in relation to FIG. 4 above. In operation 708, workspace data associated with the meeting is provided to the same AI tool. For example, the workspace data may be any one of the types of workspace data described in relation to FIG. 4 above (e.g., at least one of data from a page or database accessible by the user, a predetermined format for the meeting, content from the notes interface, or an example summary) and may be associated with the meeting by virtue of being stored in a page/database containing information about the meeting (e.g., a meeting invite, the transcription block) and/or a second page/database related to such a page/database. In some embodiments, the workspace data is determined to be associated with the meeting based on a selection from the user or based on a determination of a second AI tool (which may likewise be the same as or generally similar to an AI tool 410 as described in relation to FIG. 4 above), which determines the workspace data has a semantic meaning or other feature relevant to the content of the meeting.

In some embodiments, before providing a transcript of text based on audio content from the meeting to the AI tool, a selection from a first meeting participant to stop generating text based on audio content from the meeting is received. In response to receiving this selection from the first meeting participant, the generation of text based on audio content from the meeting is discontinued and the transcript of the text generated up to that point is provided to the AI tool. In these and other embodiments, a selection from a second meeting participant to resume transcription of the meeting is received. In response to receiving the selection from the second meeting participant, generation of text based on audio content from the meeting within the transcription block is resumed. When generation is resumed, the audio content can be received from the second meeting participant and display of the first summary within the transcription block can be discontinued.

In some embodiments, before providing a transcript of text based on audio content from the meeting to the AI tool, a detection is made that the user has left the meeting. This detection may be based on activity on the electronic device, including at least one of an audio cessation measured via an operating system-level API or a discontinuation of a specified communication protocol. In response to the detection, the generation text based on audio content from the meeting may be discontinued and the transcript of the text generated up to that point is provided to the AI tool.

In some embodiments, the audio content is received from the meeting by a meeting bot participating in the meeting. The meeting bot is an automated meeting participant that collects audio content from the meeting (e.g., using a meeting application API). While the meeting is ongoing, display may be caused, via the meeting bot and within a meeting application hosting the meeting, of at least one of a meeting transcription notification, a second summary of the transcript or a subset of the workspace data associated with the meeting. Additionally or alternatively, based on the audio content, the meeting bot can determine relevant information missing from the meeting. The meeting bot can obtain the relevant information and can present the relevant information in the meeting either through audio or through a chat associated with the meeting.

In operation 710, a first summary of the transcript is received from the AI tool. The first summary describes the content discussed within the meeting and/or supplements the transcript with data received from other sources to provide the user with an overview of the topics covered in the meeting, outstanding action items from the meeting, topics for further consideration, and the like. For example, the first summary may be the same as or generally similar to the summary 414 described in relation to FIG. 4 above. In operation 712, display of the first summary within the first transcription block is caused, thereby enabling the user to view the summary and use the summary to better understand/recall the content of the meeting. In some embodiments, the transcription block includes a CRDT that is replicated across a plurality of electronic devices. The replicas of the CRDT are configured to converge without inconsistencies, and the audio content used to generate the text within the transcription block is received from the user who selected to begin transcription of the meeting.

In some embodiments, a duplicate transcription of audio content from the meeting is detected. The detection may be based on at least one of a comparison of text based on audio content from the meeting to the duplicate transcription or the configuration of the page associated with the meeting. In response to detecting the duplicate transcription, the duplicate transcription may be discontinued.

In some embodiments, display of a query interface is caused. A query associated with the meeting may be received from the user via the query interface, and the AI tool may be directed to generate an answer to the query using the first transcript and the workspace data. The answer may then be received from the AI tool and displayed within the query interface.

In some embodiments, before receiving a selection (e.g., from a first meeting participant) to stop transcription of the meeting, a second transcript of text based on audio content from the meeting, along with the workspace data, is provided to the AI tool. A second summary of the second transcript is then received from the AI tool, and display of the second summary is caused within the transcription block.

### Computer System

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computer system 800 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 800. In some implementations, the computer system 800 can be an embedded computer system, a system-on-chip (SOC), a single-board computer (SBC) system, or a distributed system such as a mesh of computer systems or include one or more cloud components in one or more networks. Where appropriate, one or more computer systems 800 can perform operations in real time, near real time, or in batch mode.

The network interface device 812 enables the computer system 800 to mediate data in a network 814 with an entity that is external to the computer system 800 through any communication protocol supported by the computer system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computer system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computer system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded thereon, wherein the instructions, when executed by at least one data processor of a system, cause the system to:
detect that a user has entered a meeting based on activity on an electronic device, wherein the activity includes at least one of an audio system change measured via an operating system-level application programming interface (API), a use of a specified communication protocol, a calendar entry indicating a meeting time, or a configuration of a page associated with a meeting;
cause display, on the electronic device, of a notification prompting the user to begin transcription of the meeting;
receive a selection from the user to begin transcription of the meeting;
in response to receiving the selection from the user, while the meeting is ongoing, generate, in nearly real time, text based on audio content from the meeting within a transcription block,
wherein at least one of the text based on audio content from the meeting or a notes interface within the transcription block is editable by one or more meeting participants, the one or more meeting participants including the user, and
wherein the audio content is received from the user;
receive a selection from a first meeting participant to stop transcription of the meeting;
in response to receiving the selection from the first meeting participant, discontinue generating text based on audio content from the meeting and provide a first transcript of text based on audio content within the transcription block to an artificial intelligence (AI) tool;
provide workspace data associated with the meeting to the AI tool;
wherein the workspace data includes at least one of data from a page accessible by the user or database accessible by the user, a predetermined format for the meeting, content from the notes interface, or an example summary;
receive, from the AI tool, a first summary of the first transcript; and
cause display of the first summary within the transcription block.

2. The non-transitory, computer-readable storage medium of claim 1, further comprising instructions to:
before receiving a selection from a first meeting participant to stop transcription of the meeting, provide a second transcript of text based on audio content from the meeting and provide the workspace data to the AI tool;
receive, from the AI tool, a second summary of the second transcript; and
cause display of the second summary within the transcription block.

3. The non-transitory, computer-readable storage medium of claim 1, further comprising instructions to:
receive a selection from a second meeting participant to resume transcription of the meeting;
in response to receiving the selection from the second meeting participant, resume generating text based on audio content from the meeting within a transcription block,
wherein the audio content is received from the second meeting participant; and
discontinue display of the first summary within the transcription block.

4. The non-transitory, computer-readable storage medium of claim 1, further comprising instructions to:
cause display of a query interface;
receive, from the user and via the query interface, a query associated with the meeting;
direct the AI tool to generate an answer to the query using the first transcript and the workspace data;
receive the answer from the AI tool; and
cause display of the answer within the query interface.

5. The non-transitory, computer-readable storage medium of claim 1, further comprising instructions to:
detect a duplicate transcription of audio content from the meeting,
wherein the detection is based on at least one of a comparison of text based on audio content from the meeting to the duplicate transcription or the configuration of the page associated with the meeting;
in response to detecting the duplicate transcription, discontinue the duplicate transcription.

6. The non-transitory, computer-readable storage medium of claim 1, wherein the one or more meeting participants receive permission to edit at least one of the text based on audio content from the meeting or the notes interface within the transcription block via a uniform resource locator (URL) shared by the user.

7. A system comprising:
at least one hardware processor; and
at least one non-transitory memory storing instructions, which, when executed by the at least one hardware processor, cause the system to:
receive a selection from a user of an electronic device to begin transcription of a meeting;
in response to receiving the selection from the user, while the meeting is ongoing, generate, in nearly real time, text based on audio content from the meeting within a transcription block,
wherein at least one of the text based on audio content from the meeting or a notes interface within the transcription block is editable by one or more meeting participants, the one or more meeting participants including the user;
provide a transcript of text based on audio content within the transcription block to an artificial intelligence (AI) tool;
provide workspace data associated with the meeting to the AI tool;
receive, from the AI tool, a first summary of the transcript; and
cause display of the first summary within the transcription block.

8. The system of claim 7, further comprising instructions to:
detect that a user has entered a meeting based on activity on an electronic device,
wherein the activity includes at least one of an audio system change measured via an operating system-level application programming interface (API), a use of a specified communication protocol, a calendar entry indicating a meeting time, or a configuration of a page associated with a meeting; and
cause display, on the electronic device, of a notification prompting the user to begin transcription of the meeting.

9. The system of claim 7, further comprising instructions to:
before providing a transcript of text based on audio content within the transcription block to an AI tool, receive a selection from a first meeting participant to stop transcription of the meeting;
in response to receiving the selection from the first meeting participant, discontinue generating text based on audio content from the meeting and provide the transcript to the AI tool.

10. The system of claim 7, further comprising instructions to:
before providing a transcript of text based on audio content from the meeting to an AI tool, detect that the user has left the meeting based on activity on the electronic device,
wherein the activity includes at least one of an audio cessation measured via an operating system-level application programming interface (API) or a discontinuation of a specified communication protocol; and
in response to the detection, discontinue generating text based on audio content from the meeting and provide the transcript to the AI tool.

11. The system of claim 7, wherein:
the workspace data includes at least one of data from a page accessible by the user or database accessible by the user, a predetermined format for the meeting, content from the notes interface, or an example summary.

12. The system of claim 7, further comprising instructions to:
cause display of a query interface;
receive, from the user and via the query interface, a query associated with the meeting;
direct the AI tool to generate an answer to the query using the transcript and the workspace data;
receive the answer from the AI tool; and
cause display of the answer within the query interface.

13. The system of claim 7, further comprising instructions to:
detect a duplicate transcription of audio content from the meeting,
wherein the detection is based on at least one of a comparison of text based on audio content from the meeting to the duplicate transcription or a configuration of a page associated with the meeting;
in response to detecting the duplicate transcription, discontinue the duplicate transcription.

14. A method comprising:
receiving a selection from a user of an electronic device to begin transcription of a meeting;
in response to receiving the selection from the user, while the meeting is ongoing, generating, in nearly real time, text based on audio content from the meeting within a transcription block,
wherein at least one of the text based on audio content from the meeting or a notes interface within the transcription block is editable by one or more meeting participants, the one or more meeting participants including the user;
providing a transcript of the text based on audio content within the transcription block to an artificial intelligence (AI) tool;
providing workspace data associated with the meeting to the AI tool;
receiving, from the AI tool, a first summary of the transcript; and
causing display of the first summary within the transcription block.

15. The method of claim 14, further comprising:
detecting that the user has entered a meeting based on activity on an electronic device,
wherein the activity includes at least one of an audio system change measured via an operating system-level application programming interface (API), a use of a specified communication protocol, a calendar entry indicating a meeting time, or a configuration of a page associated with a meeting; and
causing display, on the electronic device, of a notification prompting the user to begin transcription of the meeting.

16. The method of claim 14, further comprising:
before providing a transcript of text based on audio content from the meeting to an AI tool, receiving a selection from a first meeting participant to stop generating text based on audio content from the meeting;
in response to receiving the selection from the first meeting participant, discontinuing generating text based on audio content from the meeting and providing the transcript to the AI tool.

17. The method of claim 14, further comprising:
receiving audio content from the meeting by a meeting bot participating in the meeting,
wherein the meeting bot is an automated meeting participant that collects audio content from the meeting using a meeting application API; and
while the meeting is ongoing, causing display, via the meeting bot and within a meeting application hosting the meeting, of at least one of a meeting transcription notification, a second summary of the transcript, or a subset of the workspace data associated with the meeting.

18. The method of claim 14, further comprising:
receiving audio content from the meeting by a meeting bot participating in the meeting,
wherein the meeting bot is an automated meeting participant that collects audio content from the meeting;
based on the audio content, determining relevant information missing from the meeting;
obtaining the relevant information; and
presenting the relevant information in the meeting.

19. The method of claim 14, wherein:
the transcription block includes a conflict-free replicated data type (CRDT) that is replicated across a plurality of electronic devices,
wherein the replicas of the CRDT are configured to converge without inconsistencies; and
wherein the audio content is received from the user.

20. The method of claim 14, wherein:
the workspace data includes at least one of data from a page or database accessible by the user, a predetermined format for the meeting, content from the notes interface, or an example summary.
